(19) United States
(12) Patent Application Publication
(10) Pub. No.: US 2018/0279018 A1
(43) Pub. Date: Sep. 27, 2018

(54) CUSTOMIZABLE AUDIO AND VIDEO FORMATS FOR DIGITAL CONTENT CONSUMPTION

(71) Applicant: International Business Machines Corporation, Armonk, NY (US)

(72) Inventors: Saurabh Dravid, Bangalore (IN); Logeswaran T. Rajamanickam, Bangalore (IN); Ashrith Shetty, Bangalore (IN); Rohit S. Shetty, Cary, NC (US)

(21) Appl. No.: 15/464,871

(22) Filed: Mar. 21, 2017

(51) Int. Cl. H04N 21/858; H04N 21/2543; H04N 21/81; H04N 21/44; H04N 21/488; H04N 21/439

(52) U.S. Cl. CPC H04N 21/8586; H04N 21/2543; H04N 21/439; H04N 21/44; H04N 21/4884; H04N 21/816

(57) ABSTRACT

A method for customizing a purchase of a digital content is provided. The method includes receiving a request from a user device to purchase the digital content retrievable by the computing system, the digital content being encoded such that the purchase of the digital content is customizable based on an audio quality and a video quality of the digital content, presenting a plurality of selectable audio formats and video formats associated with the digital content, wherein the audio quality and the video quality of the digital content is affected by a user selection of the plurality of audio formats and video formats, providing a downloadable package comprising the customized digital content with the user selected audio formats and video formats to the user device for consuming the customized digital content, and processing a payment for the customized digital content delivered to the user device.

### TECHNICAL FIELD

The present invention relates to systems and methods of customizing digital content consumption and purchasing, and more specifically to embodiments of a digital content format selection system for customizing a purchase of a digital content,

### BACKGROUND

The entertainment industry generates revenue from digital content consumption, herein the content is downloaded or streamed to a user device for consumption. To consume the content, a user may either rent or buy the digital content, which is offered as a predetermined package. In many cases, streaming the digital content uses up a user's personal data usage.

### SUMMARY

An aspect of this invention relates to a method, and associated computer system and computer program product, for customizing a purchase of a digital content. A processor of a computing system receives a request from a user device to purchase the digital content retrievable by the computing system, the digital content being encoded such that the purchase of the digital content is customizable based on an audio quality and a video quality of the digital content. A plurality of selectable audio formats and video formats associated with the digital content is presented in response to receiving the request from the user device, wherein the audio quality and the video quality of the digital content is affected by a user selection of the plurality of audio formats and video formats. A downloadable package comprising the customized digital content with the user selected audio formats and video formats is provided to the user device for consuming the customized digital content. A payment for the customized digital content delivered to the user device is processed.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a block diagram of a digital content format selection system, in accordance with embodiments of the present invention;

FIG. 2 depicts an embodiment of a user interface displayed on a user device, wherein selectable audio and video formats are presented to the user by a computing system of the digital content format selection system of FIG. 1, in accordance with embodiments of the present invention;

FIG. 3 depicts a flow chart of a method for customizing a purchase of a digital content, in accordance with embodiments of the present invention;

FIG. 4 illustrates a block diagram of a computer system for the digital content format selection system of FIG. 1, capable of implementing methods for customizing a purchase of a digital content of FIG. 3, in accordance with embodiments of the present invention;

FIG. 5 depicts a cloud computing environment,accordance with embodiments of the present invention; and

FIG. 6 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

The movie industry has always been a major revenue generating industry. As the industry grew, consumers also changed consuming habits, for example, from single screens to multiplex to digital purchase. Digital purchase of content allows consumers to either download or stream the digital content, such as movies, TV shows, documentaries, etc. Currently, if a user wants to view a movie, the user can either purchase or rent the movie. Purchasing a movie is expensive, and when a user selects a high definition (HD) movie, the user needs to worry about personal data usage for downloading and/or streaming the movie. Alternatively, the user can choose to rent the movie for a limited time, at a lower cost. But when the user rents the movie, the streaming of the movie will consume the user's own internet data. Consumption of personal data is of particular concern when the movie is offered as a predetermined package having very high video and/or audio quality, such as ultra-high definition (UHD) in Dolby Digital Atmos surround sound. Further, when a user rents or purchases the movie, the user's device and/or other hardware might be able to play or support the video format but not the offered audio format. For example, many televisions cannot decode Dolby Digital 5.1 surround, some might not support Dolby Atmos, etc. Because the renting or purchasing offer comes as a predetermined package (e.g. UHD and Dolby Digital 5.1), the user is paying for a certain quality that is not supported by the user's device, and the user assumes the risk of high personal data consumption at these audio and video formats.

Moreover, in some cases, the user wants a very high quality video, like HUD, but an average quality audio format. Alternatively, the user might have a laptop connected to a high-end brand speaker system, which means that a standard definition resolution of 480p video is sufficient, but Dolby Atmos sound is preferred. In this case, data usage is also reduced because high resolution consumes significantly more data than audio. However, current solutions do not provide the user with an option of choosing a preferred audio and video format combination, which is customized and/or tailored to the user's preferences, the user's hardware, and the user's desired personal data consumption.

In an exemplary embodiment, digital content consumption will be customizable based on a quality of audio and video format, which can be mixed and matched based on user selection. Instead of pre-packaging the digital content with very few combinations of formats, embodiments of the present invention may present multiple selections of audio and video formats at a time when the user purchases the digital content. For instance, various audio and video formats may be separately selected, and the user may be billed accordingly. As an example, if the user has a normal laptop connected to a high quality, expensive speaker, the user will be interested in viewing a movie with a high audio quality, but a lesser quality (and less expensive) video format. Currently, in this example, the user would be forced to buy the HD or UHD video format to enjoy the high quality audio, due to the prepackages offered for rent or purchase. In another example, if a user wants to buy the HD video format, but the user's television does not support Dolby Digital 7.1, the user can choose a cheaper or lesser quality audio format while maintain a higher quality video format, and pay accordingly. Embodiments of the present invention may also offer additional selectable options, such subtitles and languages, which can be paid for accordingly.

Digital content sellers may require that the content owners send the digital content (e.g. as a digital file) through one of the approved encoding houses and/or aggregators to encode or otherwise create the digital content being available as multiple, different and selectable audio and video formats. The encoded digital content may be submitted to the digital content seller. There may also be a specific way of informing the digital sellers regarding the different combinations of audio and video formats, in which the content be available to the user. For example, the various video format, audio format, subtitles, etc. may include compatibility details regarding which audio format and video format will be supported for various user devices and peripherals.

Accordingly, users may be presented with various options to buy which will help the user save money (e.g. buy only what is needed), avoid the confusion on whether digital content will play correctly or as intended on the user's device, and manage data usage. Users may choose to mix and match various audio formats and video formats to customize a purchase of digital content.

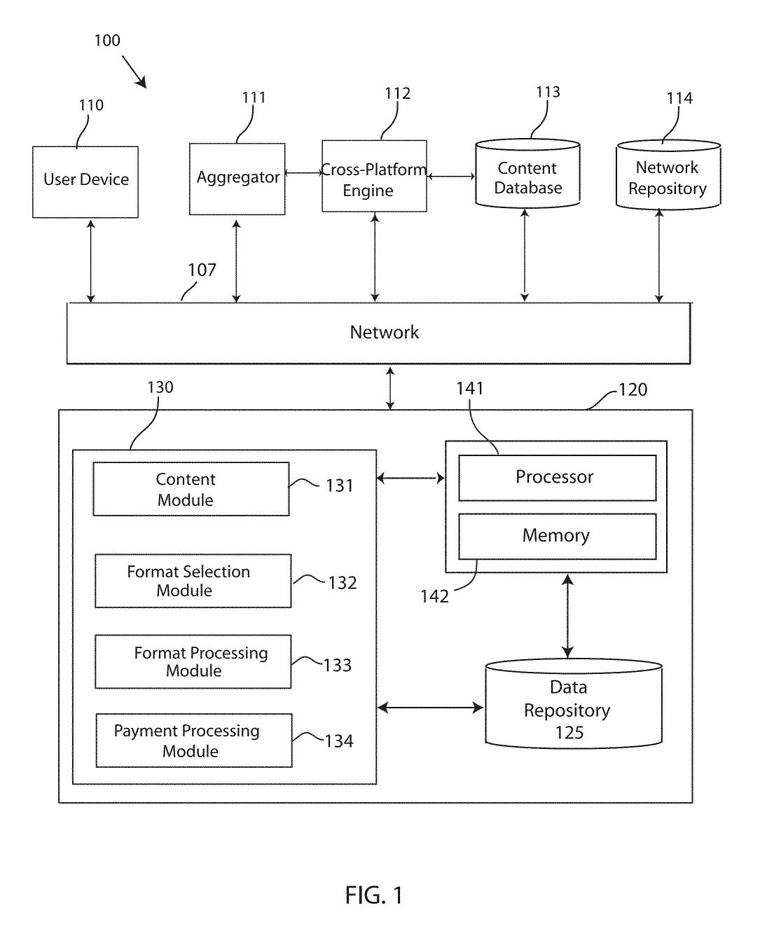

Referring now to the drawings, FIG. 1 depicts a block diagram of digital content format selection system 100, in accordance with embodiments of the present invention. Embodiments of the digital content format selection system 100 may be described as a system for customizing a purchase of digital content, based on a desired audio/video quality or compatibility of an audio format and/or video format. Embodiment of digital content format selection system 100 may comprise a user device 110 communicatively coupled to a computing system 120 of the digital content format selection system 100 over a network 107. Embodiments of the user device 110 may be a computing device, such as a computer capable of running a browser to purchase and download/stream digital content retrievable by the computing system 120. The user device 110 may also transmit payment information of the user to the computing system 120 for purposes of paying for the digital content. The type of user device connecting to computer system 120 over network 107 may vary from embodiment to embodiment. For example, user device 110 may be a laptop, a smart television, a digital media streaming device, a cell phone, a smart phone, a desktop computer, a tablet computer, and the like. As shown in FIG. 1, the user device 110 may obtain, receive, purchase, or otherwise consume digital content by connecting to computing system 120 over the network 107.

A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

Furthermore, embodiments of the digital content format selection system 100 may include an aggregator 111. Embodiments of an aggregator 111 may be an aggregator or encoding house that may format, encode, or otherwise modify original digital content provided by a content provider. The aggregator 111 may be a computing device or server associated with an aggregator or encoding house, coupled to the computing system 120. The aggregator 111 may encode a digital file provided by the content owner such that a purchase of the digital content is customizable based on an audio quality and a video quality of the digital content. For instance, the aggregator 111 may encode the digital file so that the digital content can be presented by the computing system 120 in a number of different ways, including a plurality of selectable audio and video formats, which may be combined into a downloadable file to the user, as described in greater detail infra. Embodiments of the aggregator 111 may encode details about the digital content, such as the various audio and video formats, and a compatibility associated therewith, in a data-exchange format. An example includes the following, in Java Script Object Notation (JSON) format:

```
    “movieName”: “MAD MAX : FURY ROAD”,
    “metadata”: {
    “description”: “A woman rebels against a tyrannical ruler in
postapocalyptic Australia in search for her home-land with the help of a
group of female prisoners, a psychotic worshipper, and a drifter named
Max.”,
    “ratings”: “4”,
    “reviews”: “
https://itunes.apple.com/in/movie/mad-max-fury-road/id990549112”,
    “related”: “
https://itunes.apple.com/in/movie/mad-max-fury-road/id990549112”
},
  “video”: [
      “Standard Definition”,
      “High Definition”,
      “Blu-Ray”,
      “3D”,
      “Ultra HD”
],
  “audio”: [
      “Dolby Atmos”,
      “DTS”,
      “Dolby 5.1”,
      “Dolby 7.1”,
      “Dolby 9.1”
],
  “subtitles”: [
      “English”,
      “French”,
      “Hindi”,
      “Kannada”,
      “Tamil”
],
  “compatibility”: {
      “Standard Definition”: [
          “Dolby 5.1”,
          “DTS”
],
      “High Definition”: [
          “Dolby 5.1”,
          “DTS”,
          “Dolby 5.1”
],
      “Blu-Ray”: [
          “Dolby 5.1”,
          “DTS”,
          “Dolby 5.1”,
          “Dolby 7.1”,
          “Dolby 9.1”
],
      “3D”: [
          “Dolby 5.1”,
          “DTS”,
          “Dolby 9.1”
      ],
      “Ultra HD”: [
          “Dolby 5.1”,
          “DTS”,
          “Dolby 5.1”,
          “Dolby 7.1”
]
}
  }
```

Moreover, embodiments of the digital content format selection system 100 may include a content database 113. Embodiments of the content database 113 may be one or more storage devices coupled to the computing the system 120 over network 107, which may store the digital content as modified or encoded by the aggregator 111. The content database 113 may be accessed or queried by the computing system 120, in response to a request from a user device 110 to purchase or view information regarding a particular piece of digital content stored on database 113. Further, embodiments of the digital content format selection system 100 may also include a cross-platform engine 112. Embodiments of the cross-engine platform 112 y be configured to create a downloadable file format or streamable file format, based on a combination of a number of various file formats associated with the user selected video and audio file.

In some embodiments, the network 107 may further comprise, in addition to the computer system 120, user device 110, aggregator 111, cross-platform engine 112, and content database 113, a connection to one or more network accessible knowledge bases containing information of one or more users, network repositories 114 or other systems connected to the network 107 that may be considered nodes of the network 107. In some embodiments, where the computing system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user purchases, statistics useful for the content owner and digital content sellers, etc. to generate both historical and predictive reports regarding a particular user's purchase habits and trends. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

Referring still to FIG. 1, embodiments of the computing system 120 may include a digital content purchasing application 130. Embodiments of the digital content purchasing application 130 may be an application a client, an interface, a program, or a combination of modules. In some embodiments, digital content purchasing application 130 may be loaded into the memory 142 of the computing system 120. Embodiments of the digital purchasing application 130 of the computing system 120 may include a content module 131, a format selection module 132, a format processing module 133, and a payment processing module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program cods: or linked to the program code containing specific programmed instructions, which may be loaded in the memory device of the computer system 120. A module (whether hardware, software, or a combination thereof) may be designed to implement or execute one or more particular functions or routines.

Embodiments of the content module 131 may include one or more components of hardware and/or software program code for receiving a request from a user device to purchase or view information related to the digital content retrievable by the computing system 120. Embodiments of the content module 131 may receive a request from a user device to pull up or deliver data/information to the user device regarding a particular piece of digital content. For instance, a user may search via a user interface of the computing system 120, displayed on the user device 110, for a particular movie. The content module 131 may access the content database 113 to retrieve the data/information requested by the user device 110. The digital content stored on database 113 may already have been encoded, such that the purchase of the digital content is customizable based on an audio quality and a video quality of the digital content. Embodiments of the content module 131 may then provide the details, information, data, purchasing prices, and the various audio and video format for selection by the user.

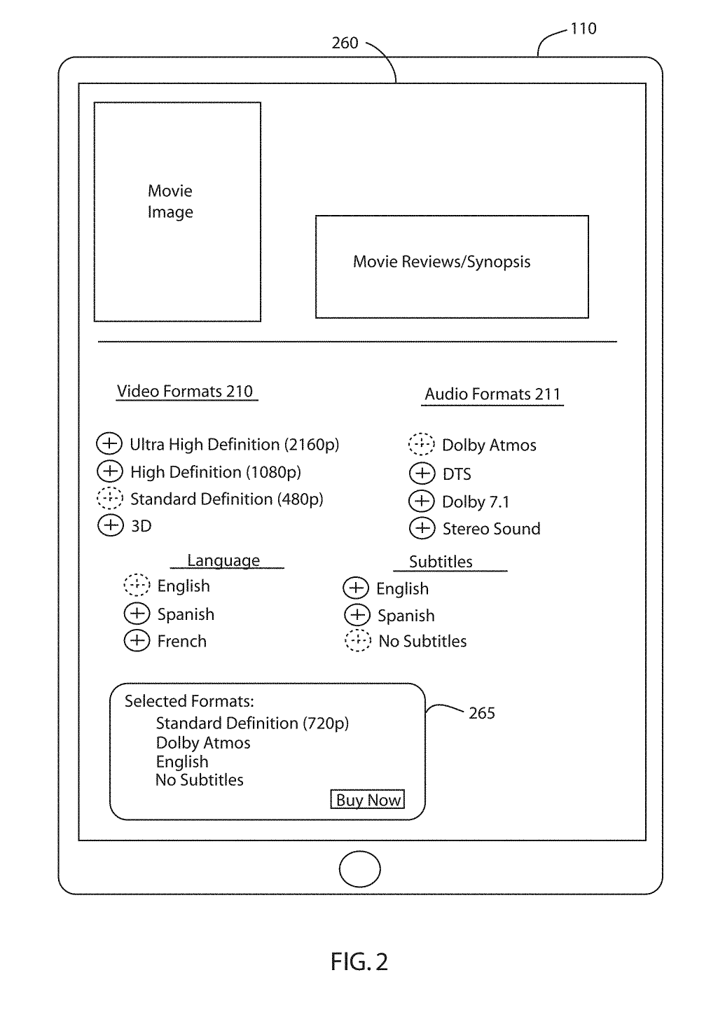

Embodiments of the computing system 120 may also include a format selection module 132. Embodiments of the format selection module 132 may include one or more components of hardware and/or software program code for presenting or providing a plurality of selectable audio formats and video formats associated with the digital content, in response to receiving the request from the user device. The audio quality and the video quality of the digital content may be determined or affected by a user selection of the plurality of audio formats and video formats. FIG. 2 depicts an embodiment of a user interface 260 displayed on a user device 110, wherein selectable video formats 210 and audio formats 211 are presented to the user by a computing system 120 of the digital content format selection system 100 of FIG. 1, in accordance with embodiments of the present invention. Embodiments of the user interface 260 may include an image representative of the digital content, a review and/or synopsis of the content, a rating, compatibility information regarding various audio and video formats, and other information associated with the content. Additionally, embodiments of the format selection module 132 may present a list of selectable video formats 210 that are selectable by the user to customize the digital content purchase to match a user's desire for a particular quality of video resolution, and/or a user's device compatibility with a particular video format. Embodiments of selectable video formats may include standard definition (SI)), 480p, 480i, 720p, 720i, high definition (HD), 1080p, 1080i, ultra-high definition (UHD), 2160p, 2160i, 4K, 5K, 8K, three-dimensional video (3D), and the like. Video formats not listed herein may also be presented to the user, including video formats not currently developed. Likewise, embodiments of the format selection module 132 may present a list of selectable audio formats 211 that are selectable by the user to customize the digital content purchase to match a user's desire for a particular quality of audio, and/or a user's device compatibility with a particular audio format. Embodiments of selectable audio formats may include Dolby® 5.1, Dolby® 7.1, Dolby® 9.1, Dolby® Atmos, Digital Theatre System (DTS), Dolby® TrueHD Apple Lossless (ALAC), Monkey's Audio, MPEG-4 SLS, stereo sound, mono, and the like. Audio formats not listed herein may also be presented to the user, including audio formats not currently developed. Further, embodiments of the format selection module 132 may provide or present additional options to customize the digital content, including a language (e.g. English, Spanish, French, Italian, Hindi, etc.) format and a subtitle option (e.g. yes/no, if yes, what language). The user may select a video format 210 and an audio format 211 from the lists, as well as other options, by interfacing with the user interface 260. The user selections may be added to a checkout area of the user interface 260.

In the example shown in FIG. 2, the user is interested in purchasing a movie, and has selected standard definition as a video format, Dolby® Atmos as an audio format, English as a language, and no subtitles. The user selections are displayed in a checkout area 265 of the user interface. In this example, the user may be watching the movie on a standard laptop with a less than optimal video resolution, but may have the laptop connected to expensive speaker system, which is capable of delivering a high quality sound. By allowing the user to customize the audio and video formats, the user does not have to pay for higher video resolution when the laptop displaying the movie would not achieve an optimum picture, but may still enjoy a crisp, high quality audio from the movie. Further, in this example, the user instead of watching on the user's laptop, may be ordering the movie through an application loaded on the user's smartphone. While the smartphone may be capable of supporting a higher resolution than SD, the user wishes to keep data usage at a minimum by selecting a lower video resolution. Various combinations of audio formats and video formats may result for various reasons.

In another embodiment, the format selection module 132 may automatically detect a type of user device that the user is using to connect to the computing system 120. Based on the detection of the type of user device, the formal selection module 132 may determine hardware and software specifications and details. Given the hardware and software details of the user device 110, embodiments of the format selection module 132 may automatically suggest an optimal configuration for highest or best quality. In another embodiment, the format selection module 132 may suggest or provide tiers of quality (e.g. optimum quality, good quality, average quality, poorest quality), based on the specific user device 110. In yet another embodiment, embodiments of the format selection module 132 may distinguish between video formats 210 and audio formats 211 compatible and not compatible with the user device 110 by color, font type, broken or solid lines, or other indicia.

Furthermore, embodiments of the computing system 120 may further include a format processing module 133. Embodiments of the format processing module 132 may include one or more components of hardware and/or software program code for providing a downloadable package comprising the customized digital content with the user selected audio formats and video formats to the user device for consuming the customized digital content. For instance, the format processing module 133 may form a download URL for the downloadable package, which may be sent to the user device 110, or made available in the checkout area 265 of the user interface 260. For instance, the download URL may be represented as a “Buy Now” link in the checkout area. Embodiments of the format processing module 133 may then facilitate the delivery of the customized digital content. Once downloaded by the user device 110, a cross-media application, such as VLC media player, may combine the files downloadable from the computing system 120. The cross-platform system may support many audio and video file formats, which may allow for a seamless playback of the digital content.

In another embodiment, the format processing module 133 may combine and/or process the user selected audio formats and video formats into a digital file comprising the customized digital content. Embodiments of the format processing module 133 may communicate with a cross-platform engine 112 to process the various combinations of audio and video formats. The cross-platform engine 112 may be connected to the computing system 120 over network 107 (as shown in FIG. 1), or may be an application or module loaded on the computing system 120. The cross-platform engine 112 may take the multiple user selected files associated with a video format and an audio format, etc., and may combine them in a way so the user device 110 may play the movie in a seamless way. The prepared file may then be provided as a downloadable package on the user interface 260 for consumption by the user.

Embodiments of the computing system 120 may further include a payment processing module 134. Embodiments of the payment processing module 134 may include one or more components of hardware and/or software program code for processing a payment for the customized digital content delivered to the user device. For example, the payment processing module 133 may receive payment processing information from the user device 110. As noted above, the user device 110 may transmit user payment account information along with a confirmation of purchasing. Thus, the payment processing module 134 may receive a communication from the user device 110 regarding payment information of the user.

Alternatively, the payment processing module 134 of the computing system 120 may communicate with an application loaded on the user device to access a local storage of the user device 110, which may contain data regarding payment accounts or payment instruments. In another embodiment, the payment processing module 134 may communicate with a remote server or remote storage device in the cloud that may include data regarding a payment account or payment instrument associated with an application loaded on the user device 110 or user account, to pay for the customized digital content.

Referring still to FIG. 1, embodiments of the computer system 120 may be equipped with a memory device 142 which may store user data, content data, payment transaction data, and the like, and a processor 141 for implementing the tasks associated with digital content format selection system 100.

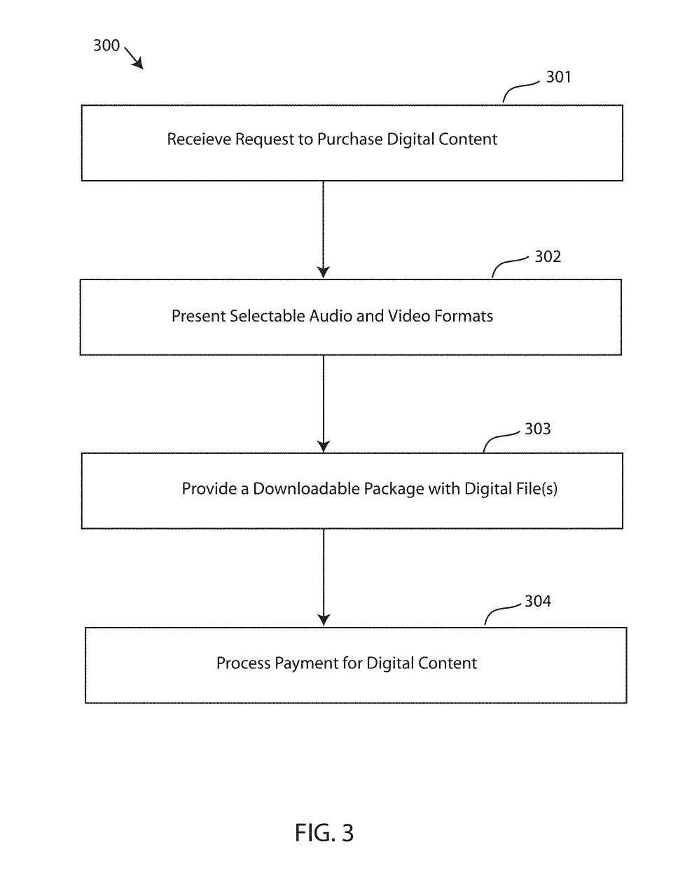

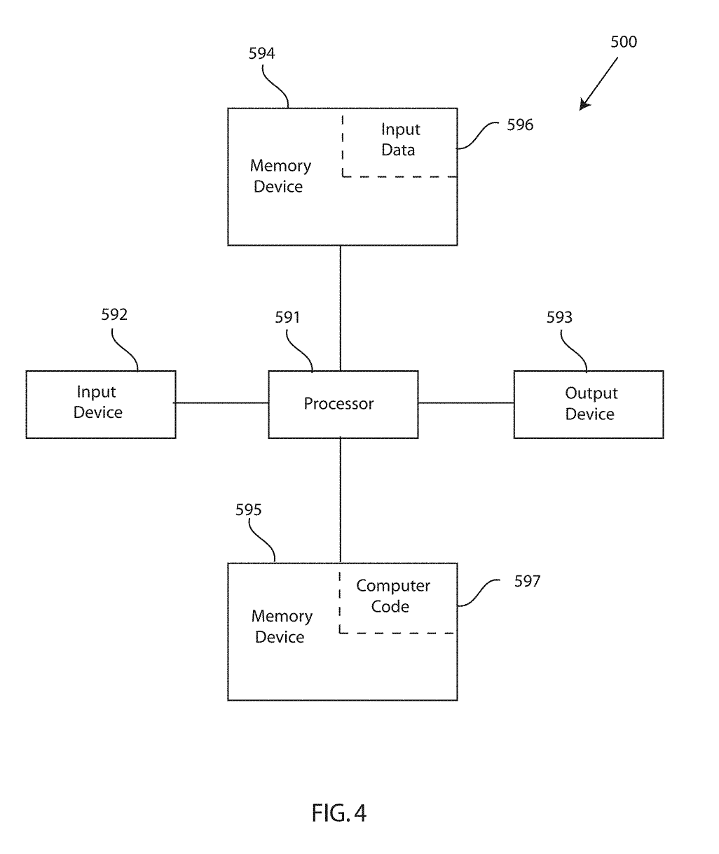

Referring now to FIG. 3, which depicts a flow chart of a method 300 for customizing a purchase of a digital content, in accordance with embodiments of the present invention. One embodiment of a method 300 or algorithm that may be for customizing a purchase of a digital content in accordance with the digital content format selection system 100 described in FIG. 1 using one or more computer systems as defined generically in FIG. 4 below, and more specifically by the specific embodiments of FIG. 1.

Embodiments of the method 300 for customizing a purchase of a digital content may begin at step 301 wherein a request to purchase or view information associated with a particular piece of digital content is received from the user device 110. For instance, a user may search a digital content selling online platform, and decide to learn more about the movie, and potentially purchase the digital movie. The information may be provided to the user. Step 302 presents a plurality of selectable video formats and a plurality of selectable audio formats for customization of the purchase of the digital content. The various video and audio formats may be selected by the user based on a desired quality of audio and/or video, a compatibility of the formats with respect to the user device, or based on an impact to personal data usage. In response to the user making various selections regarding audio and video formats, and potentially additional options, step 303 may provide a downloadable package with digital file(s), for the user to download and store or download and stream the customized content. The downloadable package may include different file formats, which may be combined by a cross-platform engine or application associated with the computing system 120 prior to sending to the user, or may be combined by a cross-platform application loaded on the user device 110. Step 304 processes a payment for the customized content.

FIG. 4 illustrates a block diagram of a computer system for the digital content format selection system of FIG. 1, capable of implementing methods for customizing a purchase of a digital content of FIG. 3, in accordance with embodiments of the present invention. The computer system 500 may generally comprise a processor 591, an input device 592 coupled to the processor 591, an output device 593 coupled to the processor 591, and memory devices 594 and 595 each coupled to the processor 591 The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for customizing a purchase of a digital content, in the manner prescribed by the embodiments of FIG. 3 using the digital content format selection system of FIG. 1, wherein the instructions of the computer code 597 may be executed by processor 591 via memory device 595. The computer code 597 may include software or program instructions that may implement one or more algorithms for implementing the methods for customizing a purchase of a digital content, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 4.

In some embodiments, the computer system 500 may further be coupled to an input/output (I/O) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may al low computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to digital content selection and customization systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide customizable audio and video formats for digital content consumption. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for customizing a purchase of a digital content. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for customizing a purchase of a digital content.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand-self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail),. The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

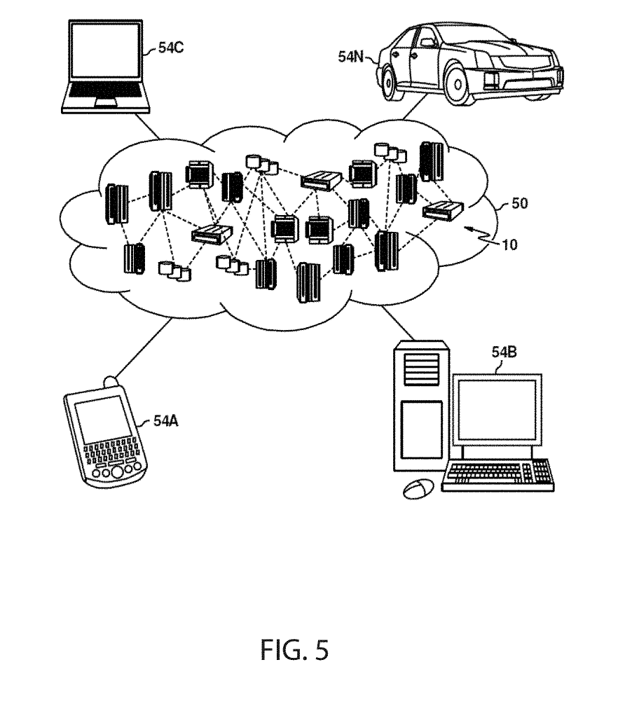

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 5 are intended to be illustrative only and that computing nodes 10 and cloud computing environment 50 can communicate with any type of computerized device over any type of network and/or network addressable connection (e.g., using a web browser)

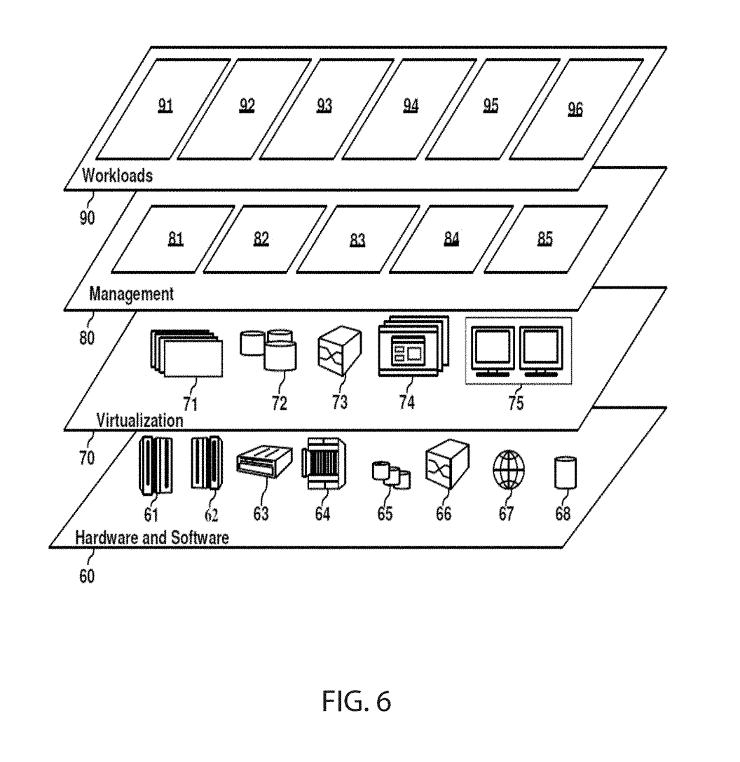

Referring now to FIG. 6, a set of functional abstraction layers provided by cloud computing environment 50 (see FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and customizable digital content purchasing and delivery 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for reducing a data usage of a user mobile device when downloading a digital content for purchase, the method comprising:
encoding, by a processor of a computing system, the digital content to support multiple different combinations of audio quality and video quality, wherein, as a function of the encoding, the digital content comprises various file formats playable by the user mobile device;
filtering, by the processor, the encoded digital content from the multiple different combinations of audio quality and video quality into a plurality of selectable audio and video formats, wherein at least one selectable video format selected by the user is a standard definition video quality to reduce a data consumption during downloading of the digital file, and at least one selectable audio format selected by the user exceeds an audio quality capability of the user mobile device;
generating, by the processor, a downloadable package comprising the digital content in a file format corresponding to the at least one selectable audio format and the at least one selectable video format that is selected by the user for downloading to the user mobile device for consuming the digital content; and
processing, by the processor, a payment for the digital content delivered to the user mobile device.

2. The method of claim 1, wherein the downloadable package includes a download URL for downloading or streaming the customized digital content, after the payment has been processed.

3. The method of claim 1, wherein the plurality of selectable video formats include standard definition, high definition, ultra high definition, and 3D,

4. The method of claim 1, wherein the plurality of selectable audio formats include Dolby® 5.1, Dolby® 7.1, Dolby® 9.1, Dolby® Atmos, Digital Theatre System (DTS), Dolby® TrueHD.

5. The method of claim 1, wherein the at least one selectable audio format and the at least one selected video formal selected by the user are combined using a cross-platform media framework, the cross-platform media framework configured to mix and match various audio and video file formats into the digital file comprising the customized digital content.

6. (canceled)

7. The method of claim 1, further comprising providing, by the processor, additional options to customize the digital content, including a language format and a subtitle option.

8. A computer system, comprising:
a processor;
a memory device coupled to the processor; and
a computer readable storage device coupled to the processor,herein the storage device contains program code executable by the processor via the memory device to implement a method for customizing a purchase of a digital content, the method comprising:
encoding, by a processor of a computing system, the digital content to support multiple different combinations of audio quality and video quality, wherein, as a function of the encoding, the digital content comprises various file formats playable by the user mobile device;
filtering, by the processor, the encoded digital content from the multiple different combinations of audio quality and video quality into a plurality of selectable audio and video formats, wherein at least one selectable video format selected by the user is a standard definition video quality to reduce a data consumption during downloading of the digital file, and at least one selectable audio format selected by the user exceeds an audio quality capability of the user mobile device;
generating, by the processor, a downloadable package comprising the digital content in a file format corresponding to the at least one selectable audio format and the at least one selectable video format that is selected by the user for downloading to the user mobile device for consuming the digital content; and
processing, by the processor, a payment for the digital content delivered to the user mobile device.

9. The computer system of claim 8, wherein the downloadable package includes a download URL for downloading or streaming the customized digital content, after the payment has been processed.

10. The computer system of claim 8, wherein the plurality of selectable video formats include standard definition, high definition, ultra high definition, and 3D.

11. The computer system of claim 8, wherein the plurality of selectable audio formats include Dolby® 5.1, Dolby® 7.1, Dolby® 9.1, Dolby® Atmos, Digital Theatre System (DTS), Dolby® TrueHD.

12. The computer system of claim 8, wherein the at least one selectable audio format and the at least one selected video formal selected by the user are combined using a cross-platform media framework, the cross-platform media framework configured to mix and match various audio and video file formats into the digital file comprising the customized digital content.

13. (canceled)

14. The computer system of claim 8, further comprising providing, by the processor, additional options to customize the digital content, including a language format and a subtitle option.

15. A computer program product, comprising a computer readable hardware storage device storing a computer readable program code, the computer readable program code comprising an algorithm that when executed by a computer processor of a computing system implements a method for customizing a purchase of a digital content, the method comprising:
encoding, by a processor of a computing system, the digital content to support multiple different combinations of audio quality and video quality, wherein, as a function of the encoding, the digital content comprises various file formats playable by the user mobile device;
filtering, by the processor, the encoded digital content from the multiple different combinations of audio quality and video quality into a plurality of selectable audio and video formats, wherein at least one selectable video format selected by the user is a standard definition video quality to reduce a data consumption during downloading of the digital file, and at least one selectable audio format selected by the user exceeds an audio quality capability of the user mobile device ;
generating, by the processor, a downloadable package comprising the digital content in a file format corresponding to the at least one selectable audio format and the at least one selectable video format that is selected by the user for downloading to the user mobile device for consuming the digital content; and
processing, by the processor, a payment for the digital content delivered to the user mobile device.

16. The computer program product of claim 15, wherein the downloadable package includes a download URL for downloading or streaming the customized digital content, after the payment has been processed.

17. The computer program product of claim 15, wherein the plurality of selectable video formats include standard definition, high definition, ultra high definition, and 3D.

18. The computer program product of claim 15, wherein the plurality of selectable audio formats include Dolby® 5.1, Dolby® 7.1, Dolby® 9.1, Dolby® Atmos, Digital Theatre System (DTS), Dolby® TrueHD.

19. The computer program product of claim 15, wherein the at least one selectable audio format and the at least one selected video formal selected by the user are combined using a cross-platform media framework, the cross-platform media framework configured to mix and match various audio and video file formats into the digital file comprising the customized digital content.

20. The computer program product of claim 15, further comprising providing, by the processor, additional options to customize the digital content, including a language format and a subtitle option.
